(19) United States
(12) Patent Application Publication
(10) Pub. No.: US 2014/0377046 A1
(43) Pub. Date: Dec. 25, 2014

(54) Compact Ramp System

(71) Applicant: Pat J. Aiello, San Diego, CA (US)

(72) Inventor: Pat J. Aiello, San Diego, CA (US)

(21) Appl. No.: 14/313,003

(22) Filed: Jun. 24, 2014

Related U.S. Application Data
(60) Provisional application No. 61/838,618, filed on Jun. 24, 2013.

(51) Int. Cl. B60P 1/43

(52) U.S. Cl. CPC B60P 1/43
USPC 414/537

(57) ABSTRACT

A ramp assembly has a ramp housing that is mounted to a truck bed and which houses a tailgate brace and a primary ramp body in a primary ramp-receiving cavity. The tailgate brace and primary ramp body are slidably engaged with the primary ramp-receiving cavity, allowing them to be switched between a collapsed and an extended configuration. The primary ramp body has a secondary ramp-receiving cavity that houses a secondary ramp body. The secondary ramp body is slidably engaged into the secondary ramp-receiving cavity, allowing it to also be switched between a collapsed and extended configuration. To widen the ramp, lateral extensions are hingedly connected to the primary ramp body and secondary ramp body. When the ramp bodies are in an extended configuration, these ramp bodies can be unfolded to effectively widen the created ramp. When not in use, the ramp bodies are easily stored within the ramp housing.

The current application claims a priority to the U.S. Provisional Patent application Ser. No. 61/838,618 filed on Jun. 24, 2013.

### FIELD OF THE INVENTION

The present invention relates generally to a ramp system which can be mounted to a truck bed and facilitates loading and unloading of cargo, goods, vehicles, and indeed anything a person wishes to place in the truck bed.

### BACKGROUND OF THE INVENTION

The need to carry cargo, goods, and a variety of additional items has been ever present throughout human history. Whether the need to transport small or large quantities, or over long or short distances, carrying cargo, goods, and additional items has been the driving force of many technological advancements. In the modern world, there are a myriad of different ways in which cargo, goods, and additional items (e.g. all terrain vehicles, motorcycles, etc.) are transported from point to point. Some of the methods of transporting cargo, goods, and additional items in the modern world include freight trains, cargo ships, and tractor trailer truck. All of these methods of transport are highly effective and capable of carry immense loads over great distances. Such methods are usually only used in commercial settings where enormous quantities of raw resources and products are transported around the globe on a daily basis. An individual person may also find the need to transport fairly large loads from one point to another. Such loads may include but are not limited to things like lawnmowers, recreational vehicles, building materials, and large mechanical parts. Pickup trucks are the ideal method for transporting such fairly large loads for individuals as opposed to large entities such as corporations and governments.

By design, pickup trucks have large beds which are raised some height off the ground by the wheels and chassis of the truck. The size of the pickup truck bed allows for quite large objects to be stored into the bed of the pickup truck, however the height of the bed can make it difficult to get large objects into the bed of the truck without assistance or using some sort of ramp. Obviously getting assistance can be quite effective but relies on others being available to come and help, something that is not so easy to accomplish in today's busy world. Using a ramp can also be effective, especially when loading objects such as lawnmowers and recreational vehicles, however most if not all ramps for pickup trucks on the market are separate parts that must be removed and stored somewhere in the bed of the truck when transport is underway. Clearly, there is significant room for improvement in the field of ramps for pickup trucks; thus it is an object of the present invention to create a ramp device for a pickup truck that is attached the bed of the truck and does not require for separate storage when transport is underway.

### BRIEF DESCRIPTION OF THE DRAWINGS

FIG. 1 is a perspective view of the present invention in a collapsed configuration.

FIG. 2 is a front view of the present invention in a collapsed configuration.

FIG. 3 is a right side view of the present invention in a collapsed configuration.

FIG. 4 is a top view of the present invention in a collapsed configuration.

FIG. 5 is a perspective view of the present invention in an extended configuration.

FIG. 6 is a right side view of the present invention in an extended configuration.

FIG. 7 is a top view of the present invention in an extended configuration.

FIG. 8 is a perspective view of the present invention in an extended and inclined configuration.

FIG. 9 is a right side view of the present invention in an extended and inclined configuration.

FIG. 10 is a perspective view of the primary ramp body with the lateral extensions in a collapsed configuration.

FIG. 11 is a perspective view of the primary ramp body with the lateral extensions in an extended configuration.

FIG. 12 is a top view of the primary ramp body with the lateral extensions in an extended configuration.

### DETAIL DESCRIPTIONS OF THE INVENTION

All illustrations of the drawings are for the purpose of describing selected versions of the present invention and are not intended to limit the scope of the present invention.

The present invention is a compact ramp system designed to be installed into the bed of a vehicle, the vehicle being a pickup truck in the preferred embodiment. The present invention comprises a ramp housing 1, a tailgate brace 2, a primary ramp body 3, and an secondary ramp body 4. The ramp housing 1 is mounted to the bed of a truck, where it used to store the tailgate brace 2, primary ramp body 3, and secondary ramp body 4 when the present invention is in a collapsed configuration. The tailgate brace 2 and the primary ramp body 3 are stored in the ramp housing 1 while the secondary ramp body 4 is stored in the primary ramp body 3. To convert to an extended configuration for use as a ramp, the primary ramp body 3 may be extended from the ramp housing 1 and the secondary ramp body 4 may be extended from the primary ramp body 3. The extended bodies can then be braced against the ground and the tailgate of the truck, creating a ramp that assists in loading and unloading of cargo, goods, and additional items.

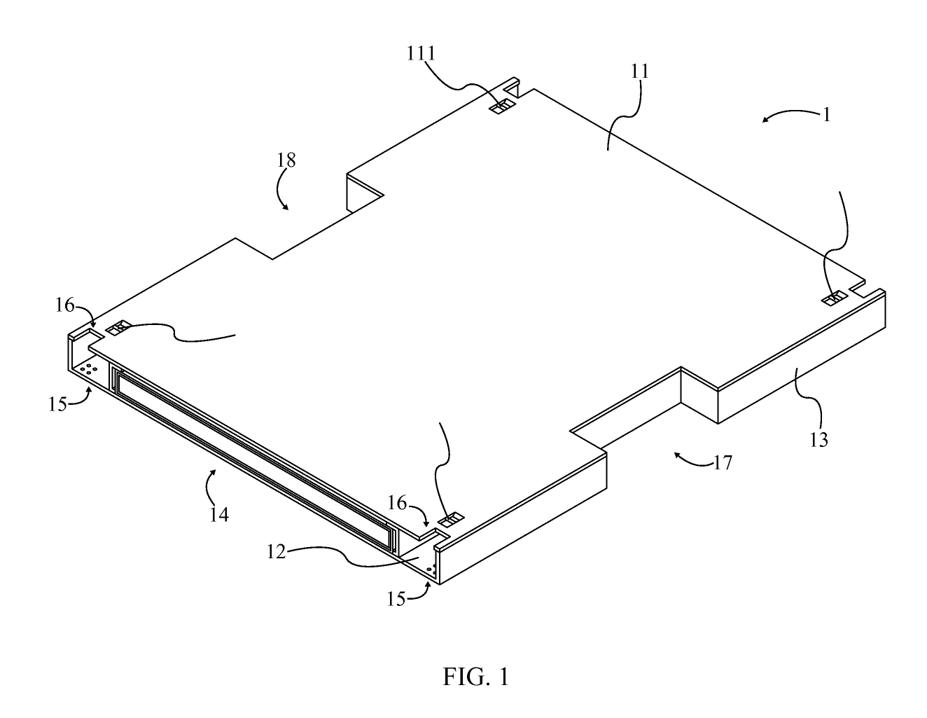

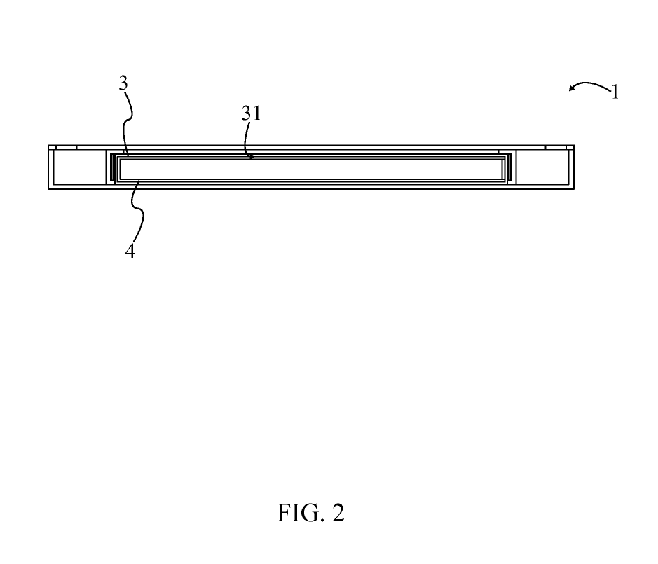

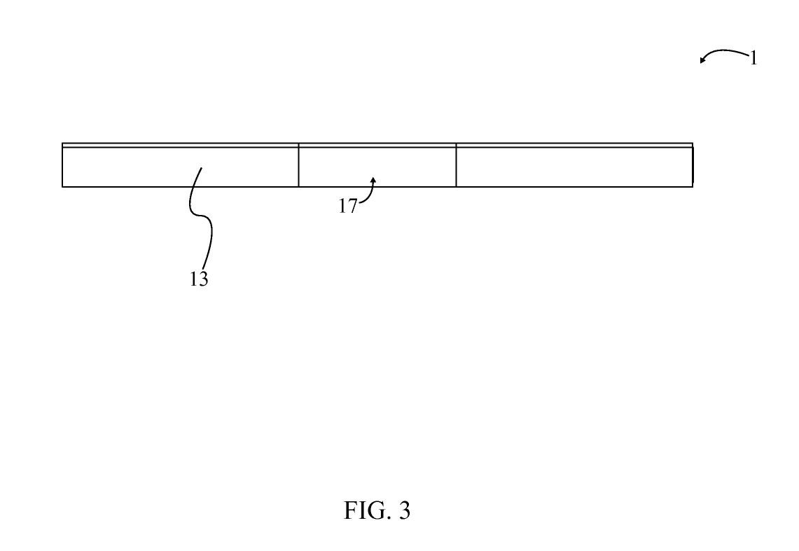

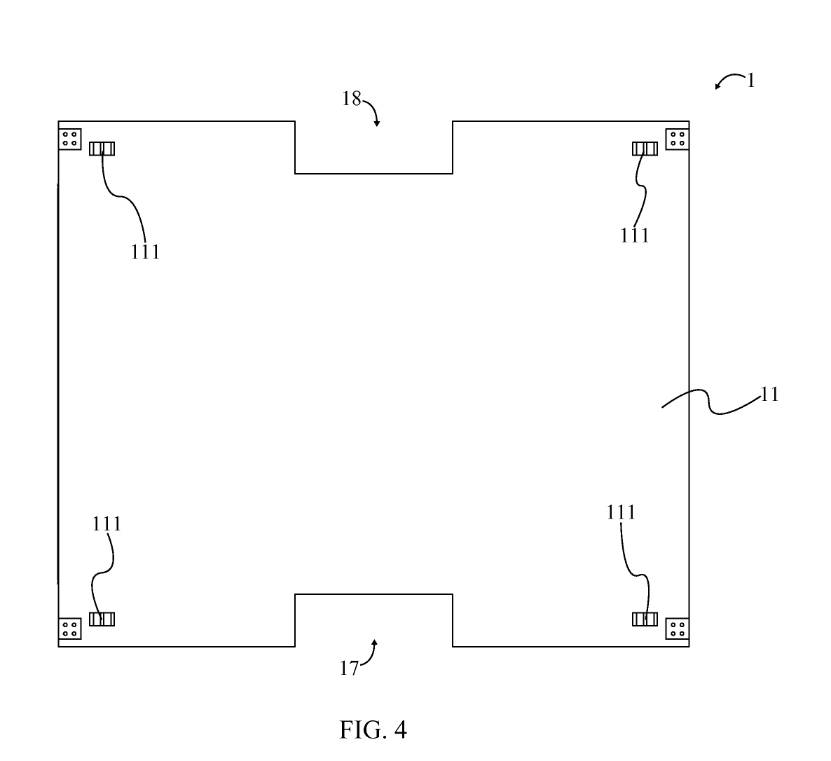

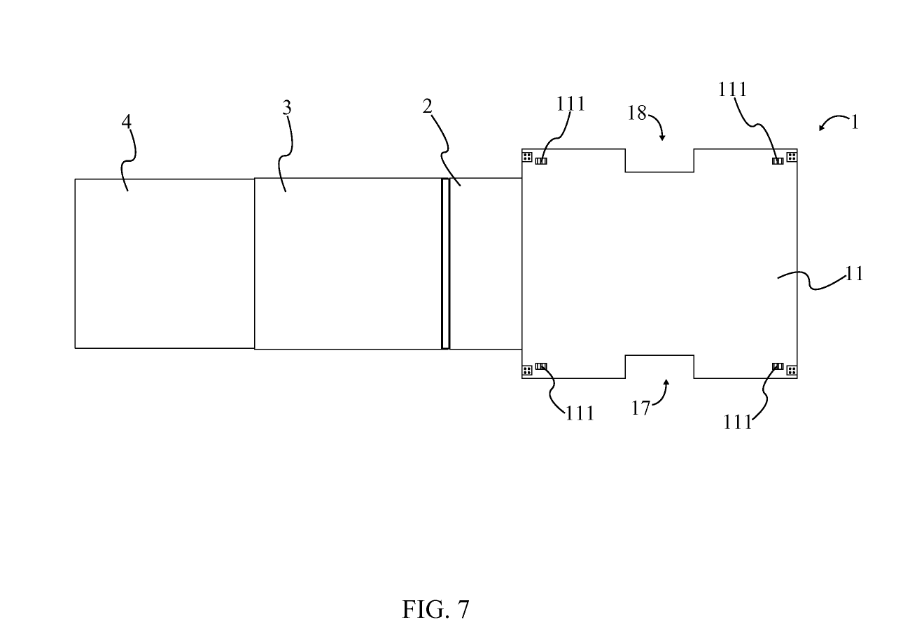

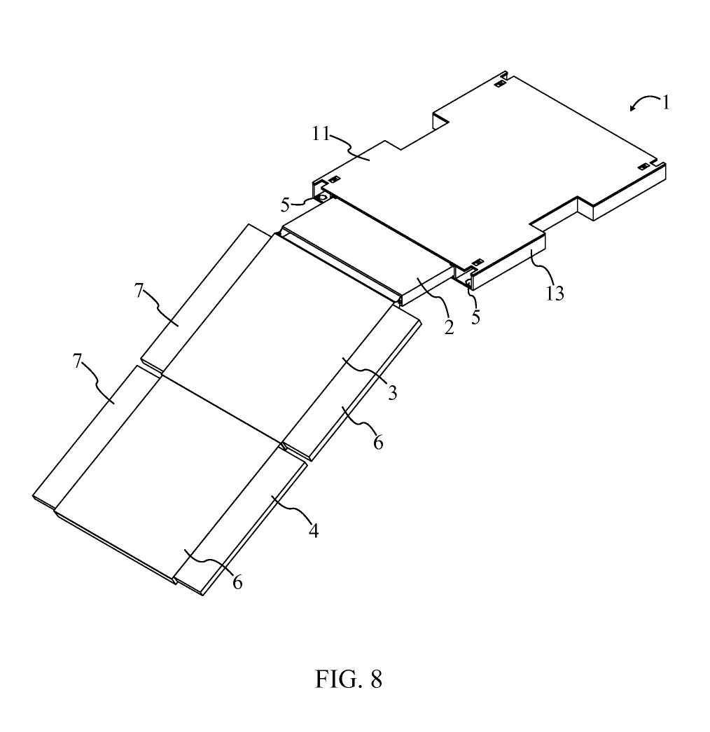

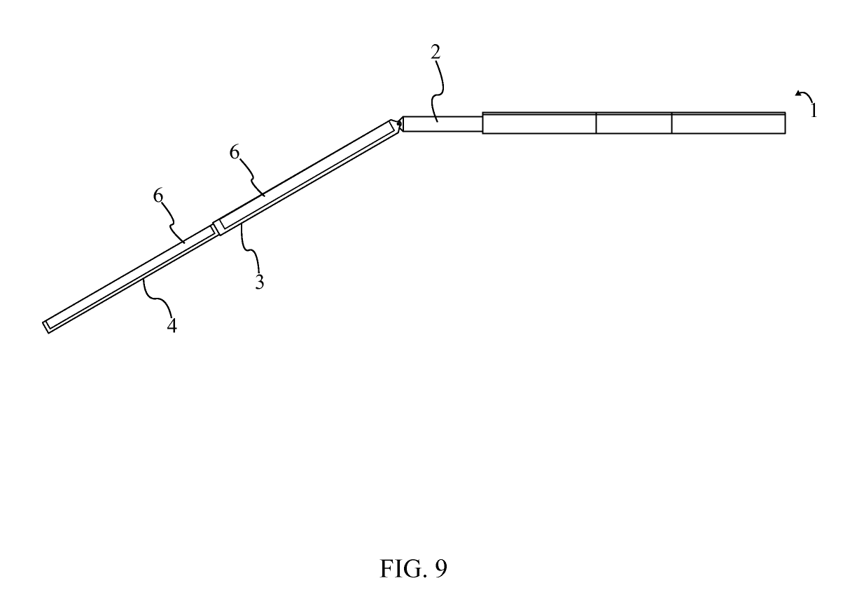

The ramp housing 1 comprises a top surface 11, a bottom surface 12, a lateral surface 13, and a primary ramp-receiving cavity 14. The primary ramp-receiving cavity 14 traverses into the lateral surface 13 between the top surface 11 and the bottom surface 12, forming a space appropriately sized for the tailgate brace 2 and primary ramp body 3. The tailgate brace 2 and the primary ramp body 3 are slidably engaged into said primary ramp-receiving cavity 14, allowing them to be moved into and out of the primary ramp-receiving cavity 14. To allow the ramp housing 1 to be mounted to a truck bed, it further comprises a plurality of mounting holes 15 and a plurality of access holes 16. The plurality of mounting holes 15 traverse through the bottom surface 12 while the plurality of access holes 16 traverse through the top surface 11. Since the plurality of access holes 16 are provided to allow a person to reach the plurality of mounting holes 15 without having to remove the top surface 11, each access hole 16 is aligned with a corresponding mounting hole 15. To physically anchor the ramp housing 1 to the truck bed, a plurality of fasteners 5 are inserted into the truck bed through the access holes 16 and the mounting holes 15. More specifically, an individual fastener is inserted to an aligned access hole and mounting hole, such that the total number of mounting holes 15, access holes 16, and fasteners 5 are equal to each other. While the specific positioning of said mounting holes 15, access holes 16, and fasteners 5 is variable, in the preferred embodiment they will be positioned along the perimeter of the ramp housing 1. The specific type of fastener used is also variable, with screws and nails being a few non-limiting examples of fasteners 5 which can be used in different embodiments of the present invention. The ramp housing is shown in FIG. 1-FIG. 9, and is most prominent in FIG. 1-FIG. 4.

As the ramp housing 1 is mounted to the truck bed, there are some additional capabilities which may be desirable to a user of the present invention. In the preferred embodiment the top surface 11 comprises a plurality of tie-down hooks 111 which are recessed into the top surface 11. These tie-down hooks 111 serve as anchors for ropes, straps, and similar restraints that are often used to secure cargo, goods, and additional items being transported in the truck bed. The tie-down hooks 111 provide a convenient attachment point for said restraints. The tie-down hooks 111 are positioned along the perimeter of the top surface 11. The perimetrical placement is preferable as placing tie-down hooks 111 in the center of the top surface 11 would slightly reduce the usable area. It is for similar reasons that the tie-down hooks 111 are recessed into the top surface 11. Recessing the tie-down hooks 111 maintains a flat surface for the ramp housing 1 for scenarios where tie-down hooks 111 are not needed.

Since truck have wheel wells that protrude into the area of the truck bed, the ramp housing 1 comprises a first wheel well cutout 17 and a second wheel well cutout 18 to accommodate for the wheel wells. These cutouts traverse into the lateral surface 13 of the truck bed, creating a recessed area that is appropriately sized for the wheel wells. The first wheel well cutout 17 and second wheel well cutout 18 effectively allow the ramp housing 1 to be positioned around the truck's wheel wells. The wheel well cutouts are necessary as a completely rectangular ramp housing 1 would be obstructed by the wheel wells, such that it could not lay flat atop the truck bed. As the wheel wells are positioned on either side of the truck, the first wheel well cutout 17 and the second wheel well cutout 18 are positioned opposite each other across the ramp housings 1, aligning them with a corresponding wheel well. The primary ramp-receiving cavity 14 is positioned between the first wheel well cutout 17 and the second wheel cutout, allowing for the primary ramp-receiving cavity 14 to have a length nearly equal to the ramp housing 1. This allows for a greater length of the primary ramp-receiving cavity 14 and thus the primary ramp body 3 and secondary ramp body 4.

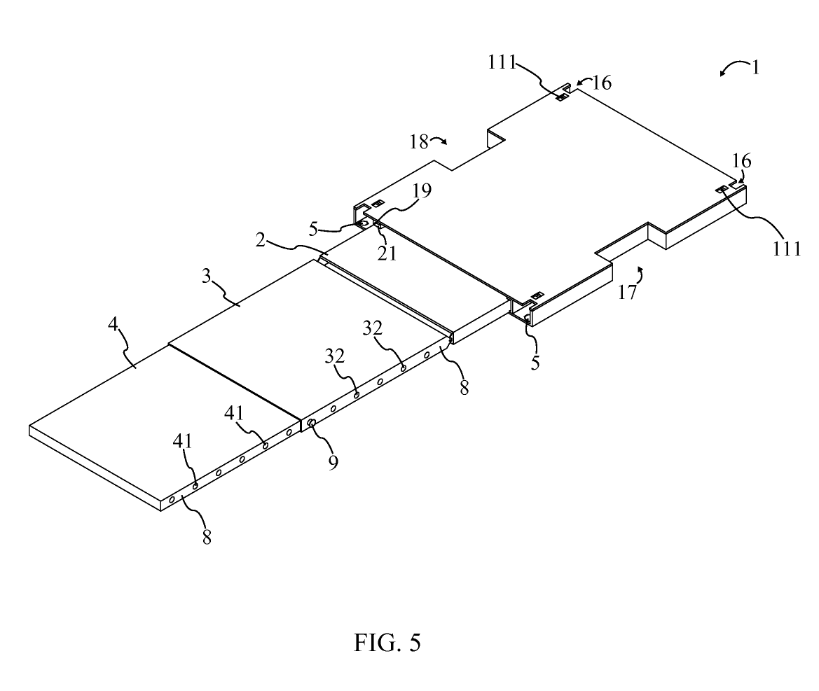

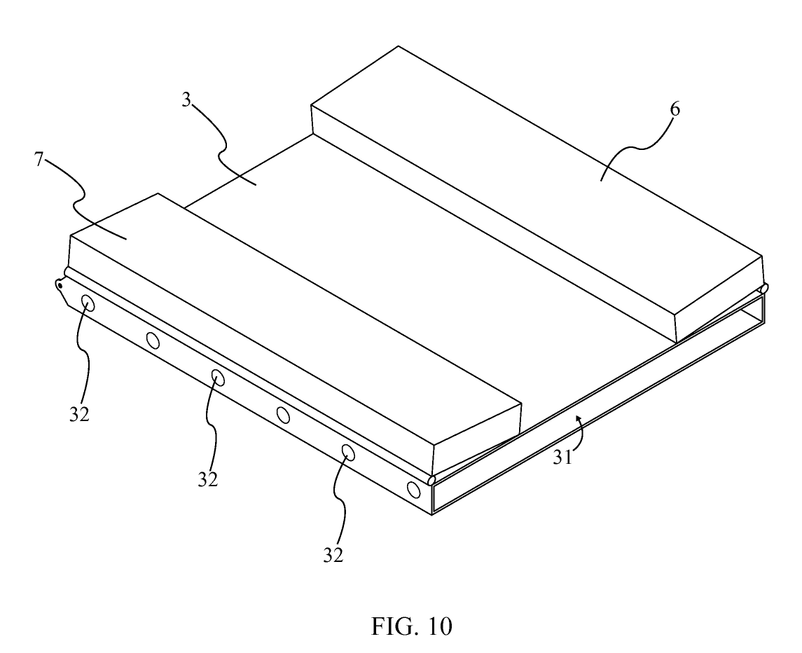

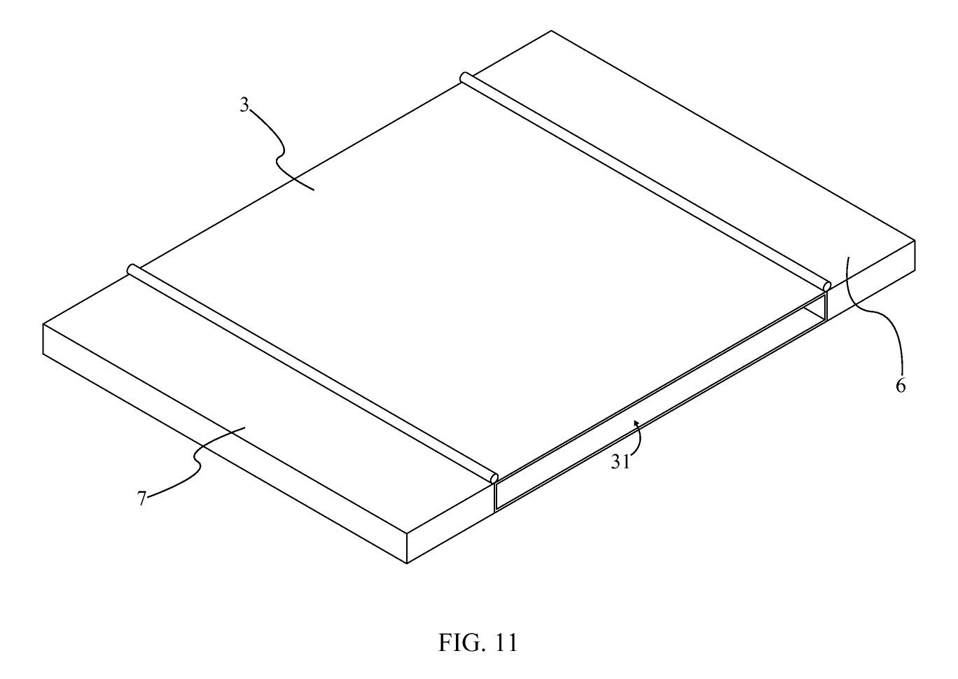

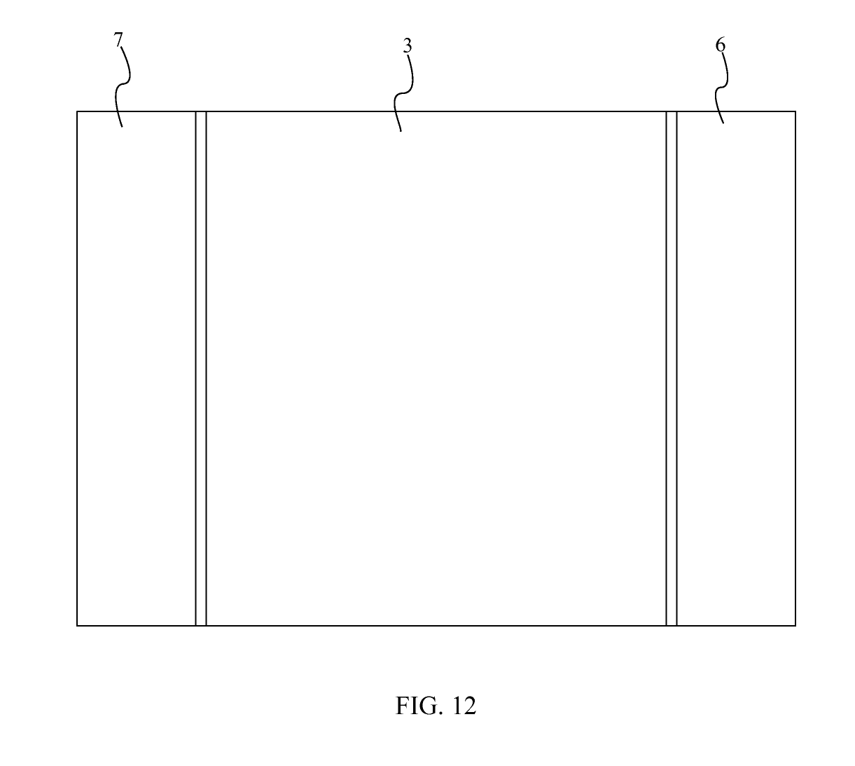

The primary ramp body 3 is hingedly connected to the tailgate brace 2, allowing the primary ramp body 3 to rotate with respect to the tailgate brace 2. This hinged connection is necessary to allow the present invention to properly function with a lowered tailgate. If the tailgate brace 2 was not provided, or if the primary ramp body 3 were rigidly connected to the tailgate brace 2, the primary ramp body 3 would not be able to rotate as it would be blocked by the tailgate. The combination of the primary ramp body 3 and the tailgate brace 2 is also made necessary by considering that the tailgate will usually be up when the truck is in motion. To allow the tailgate to close the primary ramp body 3 must be shorter than the ramp housing 1, hence the hinged connection to the tailgate brace 2. The primary ramp body 3 comprises a secondary ramp-receiving cavity 31 that houses the secondary ramp body 4. The secondary ramp body 4 is slidably engaged into the second primary ramp-receiving cavity 14, allowing it to be moved into or out of the secondary ramp-receiving cavity 31. Thus the secondary ramp body 4, along with the tailgate brace 2 and primary ramp body 3, can be switched between a collapsed configuration and an extended configuration. The primary ramp body 3 and the secondary ramp body 4 are detailed in FIG. 5-FIG. 9, while the primary ramp body 3 is independently depicted in FIG. 10-FIG. 12.

In the collapsed configuration, utilized when not unloading or loading cargo, goods, and additional items, the tailgate brace 2 and primary ramp body 3 are positioned within the primary ramp-receiving cavity 14 while the secondary ramp body 4 is positioned within the secondary ramp-receiving cavity 31. More specifically, the tailgate brace 2 is positioned adjacent to the closed end of the primary ramp-receiving cavity 14, while the primary ramp body 3 is positioned adjacent to the open end of the primary ramp receiving cavity 14. The secondary ramp body 4 is also, by proxy of the primary ramp body 3, positioned within the primary ramp-receiving cavity 14. This effectively allows the entire present invention, including ramp housing 1, tailgate brace 2, primary ramp body 3, and secondary ramp body 4, to be stored in the truck bed without taking up a large amount of space. When the truck is stopped and a user needs to load or unload cargo, goods, and additional items, the tailgate can be lowered and the ramp bodies may be converted to the extend configuration. This entails first pulling the tailgate brace 2 and primary ramp body 3 out of the primary ramp-receiving cavity 14. The resultant positioning has the tailgate brace 2 traversing into the primary ramp-receiving cavity 14, as it is prevented from being completely removed from the primary ramp-receiving cavity 14, as well as being positioned atop the lowered tailgate of the truck. The primary ramp body 3 is positioned adjacent to the tailgate brace 2, at an end opposite the ramp housing 1. This allows the primary ramp body 3 to angle down towards the ground. The secondary ramp body 4 can then be extended from the secondary ramp-receiving cavity 31, such that the secondary ramp body 4 traverses into the secondary ramp-receiving cavity 31. Further defining the secondary ramp body's 4 position, the secondary ramp body 4 is at an end of the primary ramp body 3 which is opposite the tailgate brace 2. A free end of the secondary ramp body 4, i.e. the end that does not traverse into the secondary ramp-receiving cavity 31, rests upon the ground. Thus, the primary ramp body 3 and the secondary ramp body 4 create an inclined plane that makes loading and unloading cargo, goods, and additional items easier. The collapsed configuration is illustrated in FIG. 1-FIG. 4 while the exploded configuration is illustrated in FIG. 5-FIG. 9.

Because the width of the ramp housing 1 (and subsequently the primary ramp body 3 and secondary ramp body 4) is restricted by the wheel wells, the basic ramp will not be as wide as the truck bed. It may be desirable to extend the width of the ramp to accommodate wider loads. To address this, a first lateral extension 6 and a second lateral extension 7 are provided for the primary ramp body 3 and the secondary ramp body 4. The primary ramp body 3 and the secondary ramp body 4 also each comprise a lateral portion 8. The first lateral extension 6 and the second lateral extension 7 are positioned opposite each other across their respective ramp body. Preferably the first lateral extension 6 and the second lateral extension 7 are hingedly connected to their respective ramp body. This allows the first lateral extension 6 and the second lateral extension 7 to be folded between a collapsed and extended configuration. In an embodiment with these lateral extensions, care must be taken to provide appropriate room in the primary ramp-receiving cavity 14 and the secondary ramp-receiving cavity 31. The amount of space provided should be at least as tall as the combined height of the ramp body (specifically the primary ramp body 3 with respect to the primary ramp-receiving cavity 14 and the secondary ramp body 4 with respect to the second primary ramp-receiving cavity 14) and lateral extension.

As mentioned, the hinged connections of the first lateral extension 6 and the second lateral extension 7 allow them to be switched between a collapsed and extended configuration. In the collapsed configuration (i.e. when the present invention is not in use as a ramp) the first lateral extension 6 and second lateral extension 7 are folded above the corresponding ramp body and housed within the corresponding cavity. More specifically, the first lateral extension 6 and second lateral extension 7 of the primary ramp body 3 are positioned with the primary ramp-receiving cavity 14 and atop the primary ramp body 3. Similarly, the first lateral extension 6 and the second lateral extension 7 of the secondary ramp body 4 are positioned within the secondary ramp-receiving cavity 31 and atop the secondary ramp body 4. In this collapsed configuration the first lateral extension 6 and second lateral extension 7 are positioned to take up a minimal amount of space when the present invention is not in use as a ramp.

For the first lateral extension 6 and the second lateral extension 7 to be switched to an extended configuration, the ramp bodies must first be in an extended configuration, else the lateral extensions will be prevented from unfolding due to being housed in a cavity. In an extended configuration, the first lateral extension 6 and the second lateral extension 7 are unfolded to be adjacent to the corresponding lateral portion 8. That is, the first lateral extension 6 and the second lateral extension 7 of the primary ramp body 3 are positioned adjacent to the lateral portion 8 of the primary ramp body 3, while the first lateral extension 6 and the second lateral extension 7 of the secondary ramp body 4 are positioned adjacent to the lateral portion 8 of the secondary ramp body 4. Resultantly, the first lateral extension 6 and second lateral extension 7 are coplanar with their respective ramp body, forming a widened and even ramp section. The lateral extensions are shown in FIG. 5-FIG. 12.

It is noted that other embodiments may choose to alter the implementation of the lateral extensions. For example, in one alternative embodiment the lateral extensions may be telescoping sections that are connected to the lateral portions 8 of the ramp bodies, being widened by pulling the telescoping sections out to an extended configuration. While this is a possible alternative embodiment, it is noted that telescoping sections would not be as smooth as the folding lateral extensions used in the preferred embodiment. This is just one example of an alternative implementation and not meant to limit the scope of the present invention; a number of other methods could potentially be used to widen the ramp sections to help with loading and unloading wider loads.

As described thus far, the present invention is mounted to a truck bad and can be switched between a collapsed configuration and an extended configuration, the latter being used for loading and unloading cargo, goods, and additional items. As the tailgate brace 2 and primary ramp body 3 are slidably engaged into the primary ramp receiving cavity 14, and the secondary ramp body 4 is slidably engaged into the secondary ramp-receiving cavity 31, a loading and unloading ramp can be formed by sliding the ramp bodies out of their respective cavities. This ramp can then be widened by unfolding the first lateral extension 6 and the second lateral extension 7 of the ramp bodies. This allows cargo, goods, and additional items as wide as the bed of the pickup truck to easily be loaded and unloaded by being rolled or pushed along the ramp.

To prevent the tailgate brace 2 from completely falling out of the primary ramp-receiving cavity 14, and to prevent shifting of the primary ramp body 3 and secondary ramp body 4 during use, the present invention implements a retaining system and a locking system. The retaining system prevents the tailgate brace 2 from being completely removed from the primary ramp-receiving cavity 14. To accomplish this, the ramp housing 1 comprises a tailgate brace retaining catch 19 and the tailgate brace 2 comprises a movement restraining arm 21. The tailgate brace retaining catch 19 is a protrusion that is adjacently connected to the ramp housing 1 and positioned within the primary ramp-receiving cavity 14. The movement restraining arm 21 protrudes from the main body of the tailgate brace 2, such that the movement restraining arm 21 is collinear with the tailgate brace retaining catch 19. There is a gap between the tailgate brace retaining catch 19 and both the primary ramp body 3 and the tailgate brace 2. This gap is necessary to allow free motion of the primary ramp body 3 and tailgate brace 2; the goal is not to completely immobilize said components, but rather to limit their total range of motion. This is why the tailgate brace retaining catch 19 is positioned at the opening of the primary ramp-receiving cavity 14 while the movement restraining arm 21 is positioned opposite the primary ramp body 3 along the tailgate brace 2. The movement restraining arm 21 and the tailgate brace retaining catch 19 are positioned so that they simply prevent the tailgate brace 2 from completely sliding out of the primary ramp-receiving cavity 14. As a result, a user does not need to worry about accidently pulling the tailgate brace 2 out of the primary ramp-receiving cavity 14, as the retaining components prevent that from happening. An example of this retaining system is identified in FIG. 5.

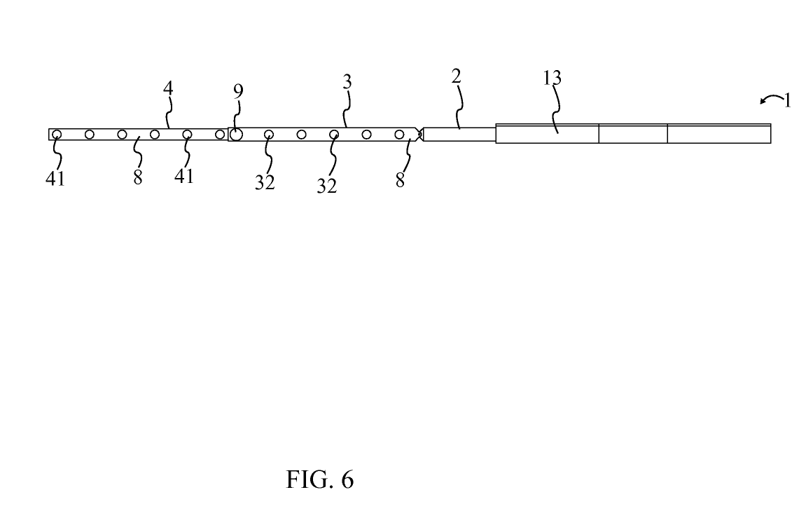

The locking system is provided for locking movement of the primary ramp body 3 and the secondary ramp body 4 with respects to each other. This is accomplished by a combination of pins and corresponding holes. At least one locking pin 9 is provided for the primary ramp body 3 and secondary ramp body 4; some embodiments may choose to provide a locking pin 9 for each side of the ramp bodies for additional security. To receive the locking pin 9, the primary ramp body 3 comprises a first plurality of pin receptacles 32 and the secondary ramp body 4 comprises a second plurality of pin receptacles 41. In the preferred embodiment the pin receptacles create apertures sized for the locking pin 9, with the first plurality of pin receptacles 32 traversing through the lateral portion 8 of the primary ramp body 3 and the second plurality of pin receptacles 41 traversing through the lateral portion 8 of the secondary ramp body 4. Furthermore, the first plurality of pin receptacles 32 and second plurality of pin receptacles 41 are positioned along their respective lateral portion 8. The secondary ramp body 4 can be locked, i.e. prevented from sliding into or out of the secondary ramp-receiving cavity 31, by inserting the locking pin 9 into one of the first plurality of pin receptacles 32 and one of the second plurality of pin receptacles 41. Since the locking pin 9 traverses through one of the first plurality of pin receptacles 32 and one of the second plurality of pin receptacles 41, undesired shifting or movement of the secondary ramp body 4 is prevented. This helps to provide a stable ramp system for loading and unloading cargo, goods, and additional items from the truck bed. The locking system also beneficial as it allows a user to effectively adjust the angle of the created ramp. If the secondary ramp body 4 is only slightly extended (creating a shorter ramp), then the angle of the ramp will be steeper. However, if the ramp body is fully extended the incline of the ramp will be lessened. This allows a user to use the more effective longer configuration when space is available, while still being able to use the ramp body with a sharper angle in constricted or confined areas. Potentially, if desired for additional security, a pin receptacle and locking pin 9 could be provided for the tailgate brace 2 and ramp housing 1, preventing the tailgate brace 2 from accidently sliding within the primary ramp-receiving cavity 14. Components of the locking system are most visible illustrated in FIG. 5 and FIG. 6.

Several alterations are possible to the described preferred embodiment without departing from the scope of the present invention. For example, while the preferred embodiment has been described with only a primary ramp body 3 and a secondary ramp body 4, additional ramp bodies and ramp-receiving cavities could be provided, allowing for the creation of a longer ramp. A third ramp body could be housed within the secondary ramp body 4, a fourth ramp body within the third ramp body, and so on. While additional ramp bodies are possible, additional ramp bodies take up more space in the truck bed and may provide little comparative advantage; while the difference between one ramp body and two ramp bodies might be a fifteen degree incline, the addition of a third ramp body might only result in an incline difference of five degrees. Effectively there are diminishing results with each added ramp body. Two ramp bodies are used in the preferred embodiment as they provide an optimal tradeoff between space requirements and effectiveness.

As earlier referenced, different mechanisms of operating the lateral extensions can be utilized, such as using telescoping lateral extensions rather than folding lateral extensions. Likewise, the mechanism of the locking system could be altered to use clamps, latches, or other alternative components which can prevent movement of the secondary ramp body 4 with respect to the primary ramp body 3. A number of mechanisms that allow the ramp bodies to slide into their respective cavities are also possible, with a common example being a rail or track setup that guides a respective ramp body. Folding caps that cover the access holes 16 can also be utilized, protecting the mounting holes 15 and fasteners 5 from the elements. The aforementioned possibilities are just a few examples of variations to the present invention. It is also noted that while the present invention has been described as being used with a truck, it is not limited to such and may be mounted to any planar surface.

Although the invention has been explained in relation to its preferred embodiment, it is to be understood that many other possible modifications and variations can be made without departing from the spirit and scope of the invention as hereinafter claimed.

What is claimed is:

1. A compact ramp system comprises:
a ramp housing;
a tailgate brace;
a primary ramp body;
an secondary ramp body;
the ramp housing comprises a top surface, a bottom surface, a lateral surface, and a primary ramp-receiving cavity;
the primary ramp-receiving cavity traversing into the lateral surface between the top surface and the bottom surface;
the tailgate brace and the primary ramp body being slidably engaged into the primary ramp-receiving cavity;
the tailgate brace being hingedly connected to the primary ramp body;
the primary ramp body comprises a secondary ramp-receiving cavity;
the secondary ramp-receiving cavity traversing into the primary ramp body opposite the tailgate brace; and
the secondary ramp body being slidably engaged into the secondary ramp-receiving cavity.

2. The compact ramp system as claimed in claim 1 comprises:
the ramp housing comprises a plurality of mounting holes and a plurality of access holes;
the plurality of mounting holes traversing through the bottom surface;
the plurality of access holes traversing through the top surface; and
each of the plurality of access holes being aligned with a corresponding mounting hole from the plurality of mounting holes.

3. The compact ramp system as claimed in claim 2 comprises:
a plurality of fasteners; and
each of the plurality of fasteners traversing through one of the plurality of mounting holes, wherein the ramp housing is mounted to a truck bed by the plurality of fasteners and the plurality of mounting holes.

4. The compact ramp system as claimed in claim 1 comprises:
the top surface comprises a plurality of tie-down hooks; and
the plurality of tie-down hooks being recessed into the top surface.

5. The compact ramp system as claimed in claim 1 comprises:
the ramp housing comprises a first wheel well cutout and a second wheel well cutout;
the first wheel well cutout and the second wheel well cutout traversing into the lateral surface;
the first wheel well cutout and the second wheel well cutout being positioned opposite each other across the ramp housing; and
the primary ramp-receiving cavity being positioned between the first wheel cutout and the second wheel cutout.

6. The compact ramp system as claimed in claim 1 comprises:
wherein the tailgate brace, the primary body, and the secondary ramp body are in a collapsed configuration;
the tailgate brace being positioned in the primary ramp-receiving cavity;
the primary ramp body being positioned in the primary ramp-receiving cavity adjacent to the tailgate brace; and
the secondary ramp body being positioned in the secondary ramp-receiving cavity.

7. The compact ramp system as claimed in claim 1 comprises
wherein the tailgate brace, the primary body, and the secondary ramp body are in an extended configuration;
the tailgate brace traversing into the primary ramp-receiving cavity;
the primary ramp body being positioned adjacent to the tailgate brace opposite the ramp housing; and
the secondary ramp body being positioned adjacent to the primary ramp body opposite the tailgate brace.

8. The compact ramp system as claimed in claim 1 comprises:
a first lateral extension and a second lateral extension of the primary ramp body;
a first lateral extension and a second lateral extension of the secondary ramp body;
the primary ramp body and the secondary ramp body each comprise a lateral portion;
the first lateral extension and the second lateral extension of the primary ramp body being positioned opposite each other across the primary ramp body; and
the first lateral extension and the second lateral extension of the secondary ramp body being positioned opposite each other across the secondary ramp body.

9. The compact ramp system as claimed in claim 8 comprises:
the first lateral extension and the second lateral extension of the primary ramp body being adjacently and hingedly connected to the primary ramp body; and
the first lateral extension and the second lateral extension of the secondary ramp body being adjacently and hingedly connected to the secondary ramp body.

10. The compact ramp system as claimed in claim 8 comprises:
wherein the first lateral extension and the second lateral extension are in a collapsed configuration;
the first lateral extension and the second lateral extension of the primary ramp body being positioned within the primary ramp-receiving cavity;
the first lateral extension and the second lateral extension of the secondary ramp body being positioned within the secondary ramp-receiving cavity;
the first lateral extension and the second lateral extension of the primary ramp body being positioned atop the primary ramp body; and
the first lateral extension and the second lateral extension of the secondary ramp body being positioned atop the secondary ramp body.

11. The compact ramp system as claimed in claim 8 comprises:
wherein the first lateral extension and the second lateral extension are in an extended configuration;
the first lateral extension and the second lateral extension of the primary ramp body being positioned adjacent to the lateral portion of the primary ramp body; and
the first lateral extension and the second lateral extension of the secondary ramp body being positioned adjacent to the lateral portion of the secondary ramp body.

12. The compact ramp system as claimed in claim 1 comprises:
the ramp housing comprises a tailgate brace retaining catch;
the tailgate brace comprises a movement restraining arm;
the movement restraining arm being collinear with the tailgate brace retaining catch within the primary ramp-receiving cavity; and
the tailgate brace retaining catch being positioned opposite the primary ramp body along the tailgate brace, wherein the movement restraining arm engages the tailgate retraining brace to prevent the tailgate brace from being removed from the ramp housing.

13. The compact ramp system as claimed in claim 1 comprises:
at least one locking pin;
the primary ramp body comprises a first plurality of pin receptacles;
the secondary ramp body comprises a second plurality of pin receptacles;
the first plurality of pin receptacles laterally traversing into a lateral portion of the primary ramp body;
the second plurality of pin receptacles traversing into a lateral portion of the secondary ramp body;
the first plurality of pin receptacles being positioned along the lateral portion of the primary ramp body;
the secondary plurality of in pin receptacles being positioned long the lateral portion of the secondary ramp body; and
the at least one locking pin traversing through one of the first plurality of pin receptacles and one of the second plurality of pin receptacles, wherein the locking pin prevents translational movement of the secondary ramp body with respect to the primary ramp body.
